(19) United States
(12) Patent Application Publication
(10) Pub. No.: US 2026/0280894 A1
(43) Pub. Date: Sep. 17, 2026

(54) SYSTEM AND METHOD FOR TRANSMITTING AND AUTHENTICATING GNSS CORRECTIONS MESSAGES

(71) Applicant: Swift Navigation, Inc., San Francisco, CA (US)

(72) Inventor: Adam Sessanna, San Franacisco, CA (US)

(73) Assignee: Swift Navigation, Inc., San Francisci, CA (US)

(21) Appl. No.: 19/566,548

(22) Filed: Mar. 13, 2026

Related U.S. Application Data
(60) Provisional application No. 63/771,386, filed on Mar. 13, 2025.
(60) Provisional application No. 63/896,963, filed on Oct. 10, 2025.

(51) Int. Cl. H04L 9/32; G01S 19/07; H04L 9/00

(52) U.S. Cl. CPC H04L 9/3242; G01S 19/07; H04L 9/50

(57) ABSTRACT

The method can include generating a payload (e.g. satellite corrections), generating a hash chain, transmitting messages containing the payload within a signing window, verifying the messages, and optionally determining GNSS receiver positions based on the messages. The method can optionally include recovering a latest state of the message stream.

### CROSS-REFERENCE TO RELATED APPLICATIONS

This application claims the benefit of U.S. Provisional Application No. 63/771,386 filed 13 Mar. 2025, and U.S. Provisional Application No. 63/896,963, filed 10 Oct. 2025, which are each incorporated in their entirety by this reference.

### TECHNICAL FIELD

This invention relates generally to the secure communications field, and more specifically to a new and useful technique for message authentication in the secure communications field.

### BRIEF DESCRIPTION OF THE SEVERAL VIEWS OF THE DRAWINGS

FIG. 1 is a schematic representation of a variant of the method.

FIG. 2 is an illustrative example of a variant of transmitting messages.

FIG. 3 is a schematic representation of a variant of generating a hash chain.

FIG. 4 is a schematic representation of a variant of recovering a latest state for a message stream.

FIG. 5 is a schematic representation of a variant of the system.

FIG. 6 is an illustrative example of a variant of the system and method.

### DETAILED DESCRIPTION OF THE INVENTION

The following description of the embodiments of the invention is not intended to limit the invention to these embodiments, but rather to enable any person skilled in the art to make and use this invention.

### 1. Overview

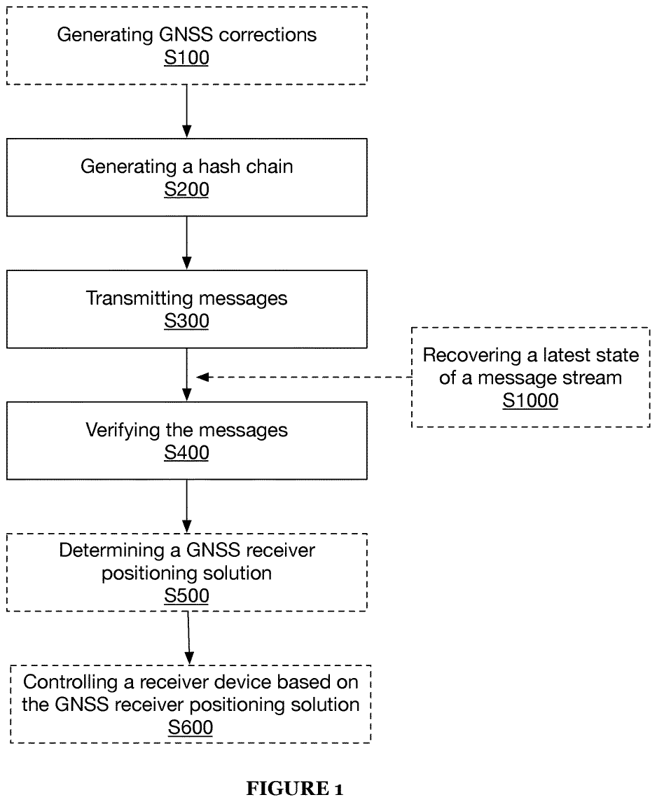

As shown in FIG. 1, the method can include optionally generating global navigation satellite system corrections S100; generating a hash chain S200; transmitting messages S300; verifying the messages S400; optionally determining a GNSS receiver positioning solution S500; optionally controlling a receiver device based on the GNSS receiver positioning solution S600; and optionally recovering a latest state of a message stream S1000. However, the method can include any other suitable steps.

Embodiments of the system and/or method can be used, for example, in autonomous or semi-autonomous vehicle guidance (e.g., for unmanned aerial vehicles (UAVs), unmanned aerial systems (UAS), self-driving cars, agricultural equipment, robotics, drones, rail transport/transit systems, autonomous trucking, last mile delivery, etc.), GPS/GNSS research, surveying systems, user devices, mobile applications, telecommunications and networking (e.g., internet-of-things (IoT) device, mobile network base stations, firmware and/or software update delivery, etc.), industrial infrastructure (e.g., supervisory control and data acquisition systems (SCADA), power grid control, industrial robotics and manufacturing line control messages, chemical pipeline signaling, etc.), civic infrastructure (e.g. emergency alert broadcast, public safety communication, etc.), and/or may be used in any other suitable application. In specific examples, the system (and/or components) can be coupled to any suitable external system such as a vehicle (e.g., UAV, UAS, car, truck, etc.), robot, railcar, user device (e.g., cell phone), and/or any suitable system, and can provide positioning data, integrity data (e.g., protection level data), and/or other data to said system.

In an illustrative example, the method can include generating a payload (e.g. satellite corrections), generating a hash chain, transmitting messages containing the payload within a signing window, verifying the messages, and optionally determining GNSS receiver positions based on the messages. The method can optionally include recovering a latest state of the message stream. Generating the hash chain can be performed by iteratively computing hash points from a random seed (e.g., using HMAC-SHA256 or any suitable cryptographic function). The hash chain can include a unique, single-use hash point for every message sent within the signing window (e.g. determined by the signing window time limit and message transmission rate). The terminal hash point of the hash chain can be signed using a signature generated from elliptical curve signature digital algorithm (ECSDA) based on the time stamp, terminal hash point, and a private key. Each message during transmission can include data (i.e., the payload), a hash point, and a message authentication code. The hash points can be transmitted with a message delay to enable delayed validation to protect from man-in-the-middle attacks. Specifically, the hash point used to validate a received message (e.g., via the message authentication code) can be sent in a message subsequent of the received message. Accordingly, a message cannot be validated until a subsequent message is received. Verifying the message can include verifying a message is legitimate using the message authentication code, verifying a message is part of the chain by hashing forward the received hash point to ensure that resultant chain leads to the signed terminal hash point, verifying the digital signature using a public key, and verifying that the messages were sent within the expected time interval using the time stamp in the signature. Recovering a latest state of the message stream can include subscribing to the message stream (e.g. via MQTT topics), receiving the latest signed terminal hash point and the disclosed hash points, verifying the signature on the signed terminal hash point to confirm its authenticity, and hashing through the disclosed hash points to ensure integrity of chain.

### 2. Technical Advantages

Variants of the technology can confer one or more advantages over conventional technologies.

First, variants of the technology can facilitate improved speed and/or security message authentication in low-power and/or low-bandwidth communication environments. In variants, the technology can support high message rates while maintaining cryptographic security guarantees (e.g., without requiring per-message asymmetric signatures). Variants of the technology can provide lightweight symmetric cryptographic operations that reduce computational overhead in resource constrained environments. By implementing efficient symmetric encryption algorithms, variants of the technology can minimize processing requirements while maintaining security protocols; thereby facilitating secure communications in applications where traditional heavyweight cryptographic methods would be impractical or prohibitively expensive in terms of computational resources. By leveraging lightweight symmetric cryptographic operations (e.g., hash computations and message authentication codes) for individual messages, variants of the technology can reduce computational load, power consumption, and bandwidth usage. This can be particularly advantageous for low-power processors, embedded systems, and wireless links with constrained throughput, such as Wi-Fi, cellular, or other IP-based communication channels, while still providing cryptographically strong authentication and integrity protection. In one specific example the method can have improved efficiency (e.g., to enable operation on low-powered devices) by using less expensive operations like HMAC-SHA256. Additionally, these less expensive operations can result in reduced bandwidth requirements for key and signature sizes. In variants, variants of the technology can utilize cryptographic operations that can be performed at high rates (e.g., 8 or more cryptographic operations per second, 16 or more operations per second, or any suitable rate) to support rapid message generation and authentication in high-frequency messaging environments.

Second, variants of the technology can ensure data integrity and authenticity through robust verification mechanisms. In variants of the technology, each message is cryptographically linked to the next, ensuring integrity. In an example of these variants, by utilizing a hash chain to link separate messages within a message chain, messages can be validated in relation to each other. In variants, the technology can utilize delayed validation to prevent man-in-the-middle (MitM) attacks. For example, by leveraging delayed hash disclosures, the technology can reduce the risk of attackers intercepting and falsifying messages. Additionally or alternatively, in variants, the signed hash end can provide a robust trust anchor for further security.

Third, variants of the technology can support mid-stream client recovery using persistent Message Queuing Telemetry Transport (MQTT) protocols, which can allow a receiver to: subscribe to a message stream mid-stream, authenticate the previously sent messages, and continue receiving the message stream. In one example, the technology can maintain session state and message queues even when clients experience temporary disconnections or network interruptions. Thus, variants of the technology that leverage this mid-stream recovery capability can improve reliability and/or reduce overhead associated with frequent connection re-establishment in unstable network environments.

Fourth, variants of the technology can provide tunable security parameters based on assessed threat levels. For instance, the system can dynamically adjust cryptographic strength, authentication requirements, and/or monitoring intensity according to real-time risk assessments or predefined security policies. For example, the delay of the key and/or hash disclosure can be modified to increase security (e.g. a hash disclose delay can be 1 message, 2 messages, 3 messages, etc.; a fixed or variable amount of time; etc.). Additionally or alternatively, in variants the hash chain length, signing window time limit, hash function type, and/or other parameters can be altered to increase security and integrity.

Fifth, variants of the technology can offer extensibility for confidentiality features through modular cryptographic frameworks (e.g., enabling the integration of additional encryption algorithms, key management protocols, privacy-preserving techniques, etc. without requiring fundamental architectural changes). In a specific example, the technology can be extended to provide confidentiality, in addition to improved assurance of data authenticity, by employing an authenticated encryption algorithm, such as AES-GCM. By using an authenticated encryption algorithm, such as AES-GCM, the system can ensure confidentiality, authenticity, and security.

Sixth, variants of the technology can facilitate cooperative operation among a plurality of receivers (e.g., a fleet of vehicles, rovers, unmanned aerial systems, marine vessels, robotic platforms, or other GNSS-enabled systems) by enabling the sharing of corrections data, validation information, hash disclosures, and/or derived positioning solutions between receivers. In variants, a first receiver that has received and/or validated one or more messages can transmit validated corrections, disclosed hash points, positioning solutions, and/or associated metadata to additional receivers within a coordinated group (e.g., a fleet of receivers), thereby reducing redundant bandwidth consumption from a central transmitter (e.g., corrections generator, transmitter, etc.) and improving resilience in environments with intermittent connectivity. This cooperative sharing can enable faster mid-stream synchronization, introduce redundancy that supports continued operation during temporary link disruptions, and facilitate coordinated navigation, formation control, collision avoidance, mapping, surveying, agricultural operations, and/or other synchronized activities. Accordingly, variants of the technology can enhance scalability, robustness, and operational efficiency in multi-receiver deployments.

However, further advantages can be provided by the system and method disclosed herein.

### 4. Method

As shown in FIG. 1, the method can include: optionally generating global navigation satellite system corrections S100; generating a hash chain S200; transmitting messages S300; verifying the messages S400; optionally determining a GNSS receiver positioning solution S500; optionally controlling a receiver device based on the GNSS receiver positioning solution S600; and optionally recovering a latest state of a message stream S1000.

The method functions to securely transmit and authenticate a sequence of messages (e.g., including a payload, authentication information, etc.). The method can be performed between a sender and a receiver. The method can be used to transmit media (e.g., video, audio, etc.), sensor and/or telemetry data, control signals and/or instructions (e.g. for drones, vehicles, industrial machines, satellites, etc.), integrity messages (e.g., flags or alerts associated with GNSS corrections or other payloads), almanac information, GNSS corrections (e.g., GNSS corrections bounds, OSR corrections, SSR corrections, etc.), map data, and/or any other data or signals. In a specific example, a sender can perform the method to transmit satellite corrections from a reference station, remote corrections generator, and/or other suitable sender to a GNSS receiver. However, the method can be performed to transmit any suitable data between any suitable entities.

In variants, the sender can function to generate the payload of the message transmission, a hash chain used for validation, authentication values and/or codes, and any other suitable information, and to then transmit the stream of messages to a receiver. The sender can perform the method utilizing a processing system, memory (e.g. non-volatile, volatile, etc.), a communication interface (e.g. wired, wireless, etc.), and a cryptographic module (e.g. software library or hardware security module to securely perform hashing, MAC computation, etc.).

In variants, the receiver can function to receive the sequence of messages and verify and/or validate the messages (e.g., using the received hash chain and authentication values). The receiver can perform the method utilizing a processing system, memory (e.g. non-volatile, volatile, etc.), a communication interface (e.g. wired, wireless, etc.), and a cryptographic module (e.g. software library or hardware security module to securely perform hashing, MAC computation, etc. for validation). Examples of receivers can include autonomous or semi-autonomous vehicles (e.g., for unmanned aerial vehicles (UAVs), unmanned aerial systems (UAS), self-driving cars, agricultural equipment, robotics, drones, rail transport/transit systems, autonomous trucking, last mile delivery, etc.), surveying systems, user devices, mobile applications, telecommunications and networking devices (e.g., internet-of-things (IoT) device, mobile network base stations, firmware and/or software update delivery, etc.), industrial infrastructure (e.g., supervisory control and data acquisition systems (SCADA), power grid control, industrial robotics and manufacturing equipment, etc.), civic infrastructure and/or any other suitable device, machine, or system.

In variants in which the receiver receives GNSS correction via the method, the receiver can utilize the verified GNSS corrections to perform real-time positioning, navigation, and/or timing (PVT) functions with high accuracy and/or integrity. Based on the corrected satellite observations, the receiver could autonomously control or adjust associated systems, devices, or machinery, including but not limited to steering, speed, trajectory, altitude, orientation, or operational mode. For example, an autonomous vehicle can adjust its steering and/or velocity to follow a precise path, a drone can maintain stable flight or coordinated formation, industrial robots can execute precise material handling or movement tasks, and wearable or mobile devices can provide accurate location-based alerts or tracking information. The high-rate reception of authenticated messages can facilitate responsive and continuous control, allowing the receiver to dynamically update actions in response to environmental changes, network conditions, or operational commands, while cryptographic validation ensures that all control decisions are based on secure and tamper-resilient data.

In variants, the system for performing the method can include: a processor (e.g., microcontroller, CPU, embedded processor, digital signal processor (DSP), FPGA, ASIC); a memory (e.g., RAM, flash memory, non-volatile storage) for storing keys, hash values, and message buffers; a cryptographic module (software library, hardware security module, or trusted platform module (TPM)); a clock or timer (e.g., system clock, GPS-disciplined clock, oscillator) to define signing windows and message timing; a transmitter (e.g., RF transmitter, satellite uplink module, network interface, antenna, etc.); a receiver (e.g., RF receiver, satellite downlink module, network interface, antenna, etc.); a communication interface (e.g., MQTT client, TCP/IP stack, wireless modem); a user device (e.g., mobile device, navigation system, IoT device, embedded module in vehicle) to consume the authenticated data; and/or any other components.

In variants, correction determination, message generation, encryption, and/or message transmission, can be performed by a corrections generation module, an encryption module, a messaging and/or transmission module, and/or any other suitable module. Each module can utilize one or more computational components, data structures, or algorithms suitable for its function. For example, a corrections generation module can leverage GNSS error models, Kalman filters, particle filters, predictive estimation algorithms, and/or any other suitable components. A message generation module can include data serialization routines, buffering schemes, and message packaging algorithms that prepare corrections and metadata for transmission. An encryption module can implement symmetric or asymmetric cryptographic algorithms, such as HMAC, AES, AES-GCM, or digital signature schemes, and can incorporate key management submodules, certificate verification submodules, and/or any other suitable modules. In variants, the encryption module can perform cryptographic operations at high rates (e.g., 8 or more operations per second, or any suitable message rate) to support real-time correction transmission, while still maintaining security and integrity. A messaging or transmission module can employ communication protocols, network interface modules, error-checking routines, retransmission algorithms, bandwidth optimization strategies, and/or any other components to ensure reliable and secure delivery. In variants, these modules can also include machine learning models, lookup tables, heuristic decision engines, learned policy, rules, and/or any other components to dynamically adapt correction computation, cryptographic parameters, or transmission scheduling based on environmental conditions, device capabilities, or assessed threat levels.

The method can include transmitting messages in a message transmission stream (e.g., signing window, validation window, etc.). The message transmission can be characterized by a signing window time, a message rate, a number of messages per signing window, and/or any other parameters. The signing window time can be between 1 and 300 seconds (e.g., 1 second, 2 seconds, 3 seconds, 4 seconds, 5 seconds, 10 seconds, 15 seconds, 20 seconds, 25 seconds, 30 seconds, 40 seconds, 50 seconds, 60 seconds, 70 seconds, 80 seconds, 90 seconds, 100 seconds, 200 seconds, 300 seconds, or any value and/or range therebetween). The signing window time can alternatively be less than 1 second or greater than 300 seconds. A shorter signing window (e.g., 5-30 seconds) can be preferable for critical and higher security systems. Longer signing windows (e.g., 60+seconds) can be used in situations when replay risk and latency tolerance is low. However, a signing window can have any suitable timeframe.

The message rate can be between 0.1 message per second (1 message per 10 seconds) and 50 messages per second (e.g., 0.1 messages per second, 1 message per second, 2 messages per second, 3 messages per second, 4 messages per second, 5 messages per second, 10 messages per second, 20 messages per second, 30 messages per second, 40 messages per second, 50 messages per second, or any value and/or range therebetween). The message rate can alternatively be less than 0.1 message per second or greater than 50 messages per second. In variants, faster message rates can be achieved using communication channels with higher bandwidth limits and/or faster processing systems. However, any message rate can be used.

The number of messages per signing window (e.g., the mathematical product of the signing window time and the messaging rate) can be between 1 message and 2000 messages (e.g., 1 message, 2 messages, 3 messages, 4 messages, 5 messages, 10 messages, 20 messages, 50 messages, 100 messages, 150 messages, 200 messages, 250 messages, 300 messages, 400 messages, 500 messages, 600 messages, 700 messages, 800 messages, 900 messages, 1000 messages, 2000 messages, or any value and/or range therebetween). The number of messages per signing window can alternatively be less than 1 message or greater than 2000 messages. In a specific variant, the message transmission can have a signing window time of 30 seconds and a messaging rate of 5 messages per second, which results in 150 messages per signing window.

In some variants, the message transmission can be performed using a corrections communication gateway. As a specific example, the message transmission can be performed as that described in U.S. patent application Ser. No. 17/379,271 titled ‘SYSTEM AND METHOD FOR PROVIDING GNSS CORRECTIONS’ filed 19 Jul. 2021 which is incorporated in its entirety by this reference. In another example, the message transmission can be performed as that described in U.S. patent application Ser. No. 18/244,567 titled ‘SYSTEM AND METHOD FOR GNSS CORRECTION TRANSMISSION’ filed 11 Sep. 2023 which is incorporated in its entirety by this reference.

The method can optionally include generating global navigation satellite system (GNSS) corrections S100, which functions to determine (e.g., calculate, estimate, generate, etc.) GNSS corrections that can be used by a GNSS receiver in determining a GNSS receiver positioning solution. In variants, the determined corrections can be a payload for message transmission. The GNSS corrections are preferably determined by a corrections generator (e.g., operating on a cloud computing server, operating on a processor collocated with a GNSS receiver, operating on an external system processor, etc.). However, the GNSS corrections can be determined using any suitable component. The GNSS corrections are preferably determined using a set of reference station observations (e.g., a set of one or more satellite signals received by one or more reference stations). However, the GNSS corrections can additionally or alternatively be determined using prior GNSS corrections, rover observations, sensor data, and/or any suitable data or information.

The GNSS corrections can include bias corrections (e.g., phase bias corrections, code bias corrections, true bias corrections, etc. for satellite and/or GNSS receiver hardware), clock corrections (for satellite and/or GNSS receiver hardware), orbit corrections, atmospheric delay (e.g., ionospheric delay, ionospheric residuals, tropospheric delay, etc.), antenna phase center, solid earth tides, solid earth pole tides, ocean tidal loading, and/or any suitable corrections.

The GNSS corrections are preferably state space representation (SSR) corrections (e.g., where different error terms are modeled and distributed separately). However, the GNSS corrections can additionally or alternatively be observation state representation (OSR) corrections (e.g., where error terms are lumped together as an observation such as for a virtual reference station as disclosed for instance in U.S. patent application Ser. No. 18/079,640, titled ‘SYSTEM AND METHOD FOR CORRECTING SATELLITE OBSERVATIONS’ filed 12 Dec. 2022 which is incorporated in its entirety by this reference) and/or any suitable corrections.

The GNSS corrections can be determined using a Kalman filter, a Gaussian process, a particle filter, and/or using any suitable estimator. For example, the GNSS corrections can be determined in a manner as disclosed in Ser. No. 17/554,397 titled ‘SYSTEM AND METHOD FOR GAUSSIAN PROCESS ENHANCED GNSS CORRECTIONS GENERATION’ filed 17 Dec. 2021 and/or U.S. patent application Ser. No. 17/347,874 titled ‘SYSTEMS AND METHODS FOR DISTRIBUTED DENSE NETWORK PROCESSING OF SATELLITE POSITIONING DATA’ filed 15 Jun. 2021, each of which is incorporated in its entirety by this reference. However, the GNSS corrections can be determined in any manner.

However, generating GNSS corrections S100 can be otherwise performed.

In other variants, a message transmission payload can be otherwise determined. Other exemplary examples of generating payload data can include measuring and/or collecting sensor values, map data, recording media (e.g. video data, audio data, etc.), computing (e.g. calculating, predicting, estimating) control setpoints, parameters, and/or instructions, or any other suitable process.

Generating a hash chain S200 and/or fingerprint chain functions to determine a sequence of fingerprints (e.g., hash points, keys). S200 can be performed by the sender. In variants, S200 can include generating a hash chain, fingerprint chain, one-way function chain, and/or any suitable chain. In variants, a chain can be a sequence of fingerprints that are interdependent (e.g., such that each fingerprint of the sequence is determined based off another fingerprint in the sequence, etc.). A fingerprint can be a value derived from a one-way transformation such as a cryptographic hash, MAC, block cipher function, modular exponentiation, irreversible mappings, or any other suitable method. In variants, the hash chain can include a plurality of unique and/or distinct hash points. In variants, the hash points can function as keys which allows a receiver to validate the received messages. In variants, each hash point can function as a one-time key. In other words, in variants, each key may not be re-used (e.g., re-sent, re-used for computing an authentication code, re-used for verification) even when intercepted by an attacker. S200 can be performed contemporaneously with S100 or any other method for payload generation (e.g. data collection, etc.). Alternatively, S200 can be performed prior to or after S100 and/or any suitable payload generation.

In variants, a hash chain can be determined using a cryptographic function (e.g., hashing function, hash function, block cipher function, MAC, encryption function, modular exponentiation, etc.) or other one-way transformation (e.g., for generating interdependent fingerprints). Examples of cryptographic functions can include HMAC-SHA256, HMAC-SHA1, HMAC-SHA512, AES-CMAC, GMAC, KMAC, Poly1305, SHA-2 functions (e.g., SHA-224, SHA-256, SHA-384, SHA-512), SHA-3 functions (e.g., SHA3-224, SHA3-256, SHA3-384, SHA3-512, SHAKE128, SHAKE256), BLAKE2S, BLAKE2b, BLAKE3, RIPEMD-160, Whirlpool, Tiger, Skein, Streebog (GOST R 34.11-2012), MD5, MD6, PBKDF2, HKDF, scrypt, Argon2, CMAC (AES-CMAC, 3DES-CMAC), VMAC, UMAC, SipHash, PRINCE, PRESENT, SIMON, SPECK, ChaCha20-Poly1305 (AEAD), Ascon (lightweight cryptography standard), PHOTON, SPONGENT, Keccak-based permutations, and/or any other cryptographic function.

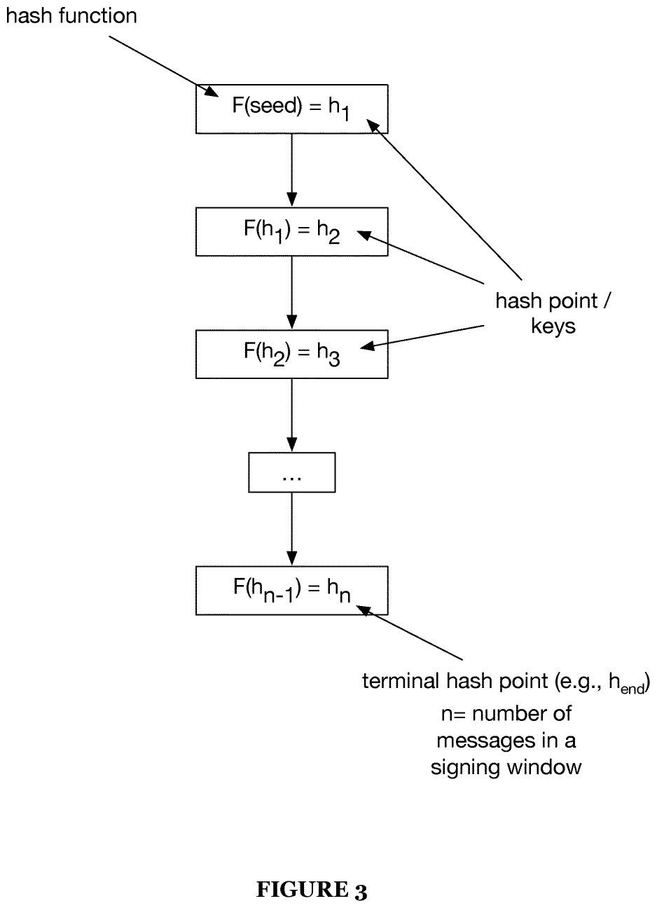

In variants, a hash chain can be determined by hashing a seed using a cryptographic function and iteratively hashing the resulting outputs until reaching the desired number of hash points (e.g. to determine a forward hash chain), as shown for example in FIG. 3. For example, a seed can be hashed to create a first hash point. The first hash point can be hashed to determine a second hash point. Iterative hashing can be performed until a predetermined number of hash points are generated (e.g., hₙ₊₁=f(hₙ) where f( ) is the hash function and hₙ and hₙ₊₁ are hash points). In variants, the seed used to initialize the hash chain can include a random seed, a predetermined seed, the payload (e.g., GNNS corrections data), a time stamp, a counter value (e.g., message number within a message chain), a hash from prior instantiation, and/or any other seed or datum. However, in some variants, the hash points can be formed along different streams (e.g., creating a first hash chain for even numbered messages and a second hash chain for odd numbered messages), and/or can be otherwise formed.

The hash chain length (e.g. number of hash points) can correspond to the number of messages per signing window. For example, a hash chain can be generated to have enough hash points such that every message in a signing window can be associated with a hash point. In an example, a sender can determine a chain of 150 hash points for a signing window with 150 messages or payloads.

In variants, the hash chain generation and associated cryptographic operations can be performed at high rates (e.g., 5 or more operations per second, 6 or more operations per second, 7 or more operations per second, 8 or more operations per second, or any suitable message rate, 9 or more operations per second, 10 or more operations per second, 16 or more operations per second, etc.), enabling real-time validation and transmission of messages even in high-frequency GNSS correction streams.

In a variant, S200 can include generating and signing a terminal hash point (e.g., hash end), h_{end}. A signature can be generated using a digital signature algorithm. Examples of digital signature algorithms can include the Digital Signature Algorithm (DSA), RSA, an Elliptic Curve Digital Signature Algorithm (ECDSA), an Edwards-curve Digital Signature Algorithm (EdDSA, e.g., Ed25519, Ed448), Schnorr signatures (including elliptic-curve Schnorr and multi-signature variants), Falcon, Dilithium, Rainbow, SPHINCS+, XMSS (extended Merkle Signature Scheme), LMS (Leighton-Micali Signature scheme), HSS (Hierarchical Signature Scheme), and/or any other suitable digital signature algorithm.

In a variant, the signature can be determined based on a timestamp, the terminal hash point, a private key, and/or any other suitable information, using the digital signature algorithm. In variants, the inclusion of a timestamp can provide a technical advantage of establishing a temporal relationship to the hash points. In these variants, each hash point is consumed within an expected time window to ensure validity and mitigate the risk of replay or man-in-the middle attacks. In these variants, the messages are rejected when they are validated or consumed beyond an acceptable time threshold relative to the hash point timestamp. By signing the terminal hash point, all preceding hash points can be cryptographically bound to the signed hash point, but can additionally and/or alternatively be otherwise bound. However, a hash point can be otherwise signed.

While in variants, it is preferable to sign the terminal hash point, other variants can additionally or alternatively include signing an initial hash point, one or more internal hash point (e.g. a hash point within the chain, key hash points, etc.), or any other suitable hash point.

However, generating a hash chain S200 may be otherwise performed.

While S200 describes determining a hash chain, the method can include determining any interdependent sequence of fingerprints or one-way function chain using any suitable method (e.g. using cryptographic hash functions, MAC, block cipher function, modular exponentiation, irreversible mappings, etc.). While S200 is described using hash chains, hash points, and hash functions, the method is not limited to this framework for generating an interdependent fingerprint sequence.

Transmitting messages S300 functions to send a series of messages that can be authenticated by a receiver. S300 can be performed by the sender. S300 can be performed after generating the hash chain S200 and generating the message payload (e.g., corrections generated in S100). S300 can be transmitted continuously, iteratively, sporadically, contemporaneously, or at any suitable frequency during the signing window.

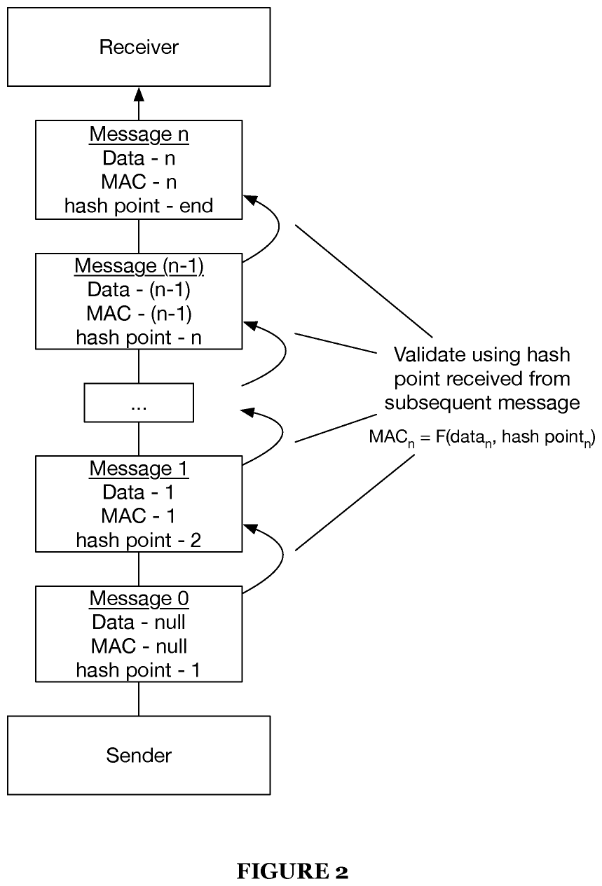

Each message can include data (e.g., a payload, GNSS corrections), a hash point (e.g. from the hash chain generated in S200), a message authentication code, and optionally a sequence number, as shown for example in FIG. 2. The data (e.g., ‘D’) can include corrections data (e.g., GNSS corrections or subsets thereof), integrity messages, almanac information, map data, and/or any other data or payload. The message authentication code (e.g., MAC, HMAC, etc.) can be generated based on the data and hash point using a cryptographic function (e.g., MACₙ=f(Dₙ, hₙ)). The cryptographic function for generating the MAC can be the same cryptographic function or a different cryptographic function from that used to generate the hash chain. Optionally, the message can include a sequence number. In variants, including an explicit sequence number can provide an additional safeguard against replay attacks and/or simplify the detection of out-of-order messages. While the hash points inherently serve as sequence markers, this redundancy (in variants that include it) can provide greater robustness in environments with potential timing discrepancies. In some variants (e.g., based on bandwidth constraints, timing between payload generation such as for different corrections terms, etc.), payloads can be grouped to be sent in separate messages (e.g., to conserve message bandwidth) such as in a manner as described in U.S. patent Ser. No. 18/665,225 titled ‘SYSTEM AND METHOD FOR GNSS CORRECTION TRANSMISSION’ filed 15 May 2024 which is incorporated in its entirety by this reference.

In variants, the sequence numbers count down from the total number of messages in the signing window (e.g., n, n−1, n−2, n−3, etc. where n is the total number of messages). However, in other variants, the sequence numbers can count up to the total number of messages. The sequence numbers can be otherwise ordered.

In a variant, each message can include a hash point associated with a preceding message (e.g., for delayed validation). For example, delayed hash point transmission (e.g., message rachets, hash point disclosure delays) can be used to ensure that a message cannot be validated until one (or more) subsequent messages are received. Delayed validation can provide a technical advantage of protecting the sender and receiver from man-in-the-middle (MitM) attackers and/or prevent attackers from falsifying messages in real time. For example, without delayed hash points, an attacker could intercept a valid message, modify its payload, and recompute a valid MAC using the disclosed hash point. Delayed validation can ensure that the key for each MAC is revealed after the message it secures has been transmitted, closing this security gap. In variants, hash point transmission can be delayed between 1 and 20 messages or any range or value therebetween (e.g., 1 message, 2 messages, 3 messages, 4 messages, 5 messages, 10 messages, 20 message, or any value therebetween). The hash point transmission can alternatively be delayed for less than 1 message (e.g., no delay) or greater than 20 messages. Larger delays (e.g. increased message rachet) can be preferable for situations with high risk and/or interception threat, but can additionally and/or alternatively be otherwise utilized.

In a first specific example, a series of messages can have a hash point 1-message disclosure delay, meaning that an initial message cannot be authenticated until the next message is received, where the next message includes the hash point used for validating the initial message. In another specific example, a series of messages can have a hash point transmission delay of two messages, meaning that an initial message cannot be authenticated until a second message and a third message are received, where the third message and/or a combination of the second and third message can include the hash point used for validating the initial message.

In a variant, the hash points can be sent via the messages (e.g. disclosed) in the order from h_{end} to h₁ (e.g., h_{end}, h₁₄₉, h₁₄₈, h₁₄₇, . . . , h₁; backward hash disclosure, reverse hash disclosure, etc.). In another variant, hash points can be sent in the opposite order (e.g., h₁, h₂, h₃, . . . h₁₄₉, h_{end}; forward hash disclosure). However, hash points can be transmitted in any suitable order.

In variants in which backward hash disclose is performed, the first message sent during the signing window can include or be sent with the terminal hash point, h_{end}. In variants, h_{end} can include the signature generated in S200. Sending the signed hash point as the first message or with the first message can allow the receiver to verify the message using the signature prior to receiving all the messages. In these variants, the last message of the signing window can include an empty and/or null payload and a hash point for the preceding message. This last message can function to close the signing window.

In an illustrative example for descriptive purpose only, a signing window with payloads and a hash delay of 1 message can include first transmitting the signed terminal hash point h_{end} and then transmitting the messages:

$${M}_{5} = ( {D}_{5} , {MAC}_{5} , null hash ) ;$$

$${M}_{4} = ( {D}_{4} , {MAC}_{4} , {h}_{5} ) ;$$

$${M}_{3} = ( {D}_{3} , {MAC}_{3} , {h}_{4} ) ;$$

$${M}_{2} = ( {D}_{2} , {MAC}_{2} , {h}_{3} ) ;$$

$${M}_{1} = ( {D}_{1} , {MAC}_{1} , {h}_{2} ) ;$$

$${M}_{0} = ( null payload , {h}_{1} ) ;$$

In this specific example, the subscripts on the messages and data (e.g., D₅, D₄, . . . , D₁) are used to denote their relationship to the corresponding hash-chain elements (h₁, h₂, . . . , h₅, h_{end}) and do not necessarily denote order of transmission. For example, the data can be sent in chronological order (i.e., in the order from top to bottom for the above example messages). Specifically, the chronological and/or intelligible order of the payload can be D₅, D₄, D₃, D₂, D₁. In this representation, the sequence numbers are counting down from the message count. In a variation of this illustrative example, h_{end} can be transmitted as part of M₅.

However, transmitting messages S300 may be otherwise performed.

Verifying the messages S400 can function to ensure that the messages received after transmission are authentic and/or valid. Verifying (e.g., validating, authenticating, checking, etc.) the messages can be performed by the receiver. Verifying the messages can be performed after a message is received, after the entire message stream is received, after a subset of the messages are received, after the signing window is closed, or at any suitable time. In variants, messages can be verified continuously as messages are received, after all messages of the signing window are received, periodically (e.g., every 5 seconds, every 10 seconds, every 20 seconds, every 30 seconds, and/or any suitable amount of time), after receiving a predetermined number of messages (e.g., every 5 messages, every 10 messages, every 20 messages, and/or any suitable frequency), or in any other suitable manner. Verifying the messages S400 can include verifying that a message is part of the chain, verifying a message is legitimate (e.g., to verify that the message was not falsified or changed), verifying the entire message chain (e.g., to determine the chain of messages is from the known sender, etc.), and/or verifying the transmission time of the messages (e.g., to ensure that the message was sent in the expected time window, etc.)

In a first variant, verifying the messages S400 can include verifying that a message is part of the message chain. In variants, verifying that a message is part of the chain can include hashing forward the hash point of a message (e.g., using the cryptographic function) and/or verifying that the resultant hash chain leads to the known terminal hash point (h_{end}). For example, if a receiver receives h₄ in a message, the receiver can compute h₅, h₆, h₇, and every subsequent hash point using the hash function until h_{end} is determined. The computed hash points can be compared to the known, disclosed hash points (e.g., received in preceding messages, etc.) to verify that the message is part of the chain. However, verifying that a message is part of the message chain can include any suitable steps or be performed in any suitable manner.

In a second variant, verifying the messages S400 can include verifying that a message is legitimate. Verifying that a message is legitimate can include computing the message authentication code for a message using the associated hash point (and/or a hash point from a prior or subsequent message) and cryptographic function and confirming that the computed MAC is equivalent to the MAC received via transmission for the message. In variants in which transmission of hash points are delayed, delayed validation can be performed using the subsequently received message. The delayed validation can include receiving a subsequent message after an initial message (e.g. to receive the hash point for the initial message), computing the message authentication code of the initial message using the initial message data and the associated hash point (e.g., received in the subsequent message) with the cryptographic function, and/or verifying that the computed message authentication code is equivalent to the message authentication code received with the initial message. However, verifying that a message is legitimate can include any suitable steps or be performed in any other suitable manner.

In a third variant, verifying the messages S400 can include verifying the message chain. In variants, verifying the message chain can include verifying the signature (e.g., on h_{end} or any signed hash point). Verifying the signature can include computing the signature from the signed hash point, the known timestamp a public key, and/or any other suitable information using the digital signature algorithm and verifying that the computed signature is equivalent to the received signature. In variants, the timestamp, public key, and other information used for verifying the signature can be provided to the receiver through message transmission, through distribution via an organizational network, using a digital certificate, and/or any suitable method. However, verifying the message chain can include any suitable steps or be performed in any other suitable manner.

In a fourth variant, verifying the messages S400 can include verifying the transmission time of the messages. In variants, verifying the time can include ensuring that each received message was transmitted in the signing window specified by the timestamp contained within the signature (e.g., on h_{end} or on any other signed hash point). In these variants, hash points are consumed within a certain interval of the timestamp to ensure time validity. In these variants, hash points and/or messages are rejected when they are validated or consumed beyond an acceptable time threshold relative to the hash point timestamp to protect against replay attacks. However, verifying the transmission time of the messages can include any other suitable steps and/or be performed in any other suitable manner.

Verifying the messages S400 can include performing each of the aforementioned verification processes or a subset of the aforementioned verification processes. For example, in variants, the messages may not be deemed “verified” until all verification processes are performed.

However, verifying the messages S400 may be otherwise performed.

The method can optionally include determining a GNSS receiver positioning solution S500, which functions to determine (e.g., estimate, calculate, etc.) a kinematic solution (e.g., position, velocity, speed, acceleration, attitude, time, etc.) of the GNSS receiver (and/or external system). The GNSS receiver positioning solution is preferably determined using a positioning engine (e.g., a positioning engine of a computing system collocated with the GNSS receiver, a cloud positioning engine, etc.), but can be determined by any suitable component.

The GNSS receiver positioning solution is preferably determined using corrected satellite observations (e.g., the GNSS receiver satellite observations determined from satellite signals received by the GNSS receiver corrected using the corrections from the message), but can be determined using any suitable satellite observations (e.g., uncorrected satellite observations, differenced satellite observations, etc.). The satellite observations can be precorrected (e.g., before a filter or estimator processes the satellite observations to determine the GNSS receiver positioning solution), corrected in an estimator (such as a Kalman filter, extended Kalman filter, unscented Kalman filter, particle estimator, Gaussian process, etc.; where the GNSS corrections can be an input to the estimator), and/or can otherwise be corrected.

The positioning solution is preferably determined using carrier phase (e.g., ambiguity resolved carrier phase), but can additionally or alternatively be determined using pseudorange, doppler, and/or any suitable satellite signal(s). Determining the positioning solution can include determining the carrier phase ambiguity (e.g., to a floating point precision, to integer precision, etc. such as disclosed in U.S. patent application Ser. No. 16/817,196 filed 12 Mar. 2020 entitled “SYSTEMS AND METHODS FOR REAL TIME KINEMATIC SATELLITE POSITIONING” or in U.S. patent application Ser. No. 17/022,924 filed 16 Sep. 2020 entitled “SYSTEMS AND METHODS FOR HIGH-INTEGRITY SATELLITE POSITIONING,” each of which is incorporated in its entirety by this reference), determining a set of floating phase ambiguity hypotheses, determining a set of integer phase ambiguity hypotheses from the set of floating phase ambiguity hypotheses, performing hypothesis testing to validate the set of integer phase ambiguities hypotheses, and/or any suitable steps.

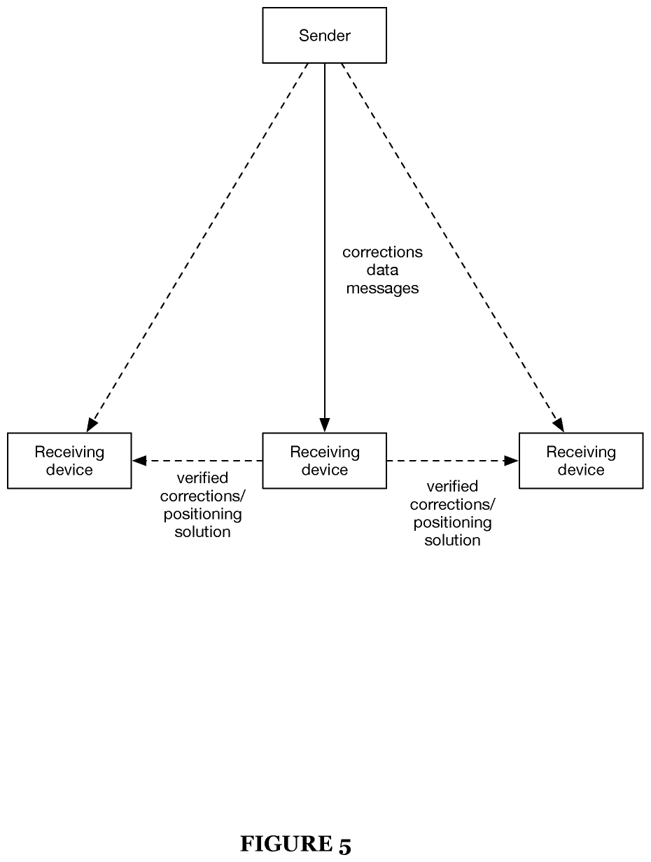

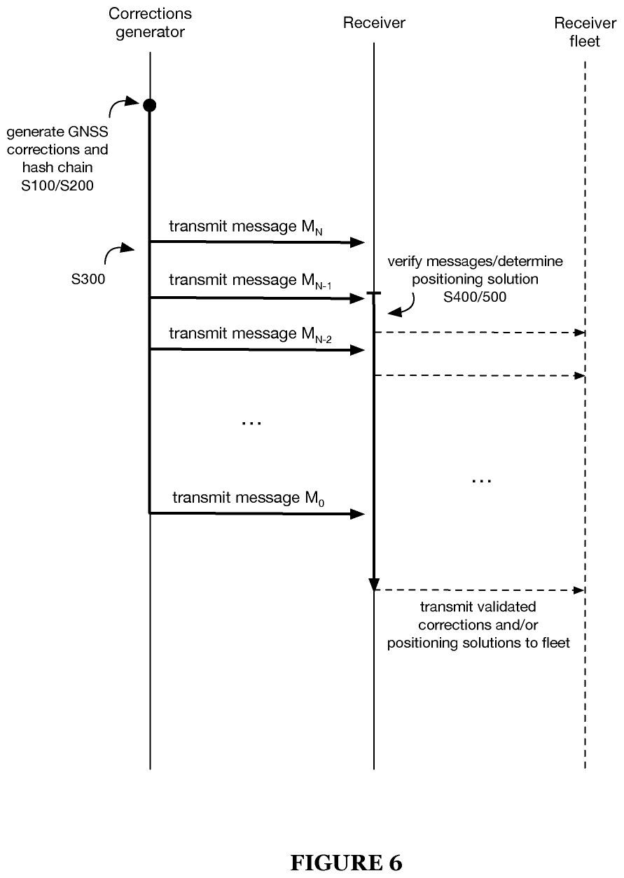

In variants, determining the GNSS receiver positioning solution S500 can further include transmitting the positioning solution, one or more validated messages, one or more unvalidated messages, and/or one or more disclosed hash points to another receiver and/or to a plurality of receivers, as shown for example in FIG. 5 and FIG. 6. For example, a first receiver that has received GNSS corrections and determined a positioning solution can function as a relay or secondary distribution node for additional receivers operating within a coordinated system (e.g., a fleet of autonomous vehicles, robotic devices, drones, industrial machines, agricultural equipment, or any other suitable systems). The transmission can occur over a local wireless network, ad-hoc mesh network, vehicle-to-vehicle communication link, satellite link, cellular link, or any other suitable communication interface.

In variants, the first receiver can transmit the originally received authenticated messages without modification, allowing downstream receivers to independently perform verification using the signed terminal hash point and disclosed hash points. In other variants, the first receiver can transmit a subset of messages, aggregated corrections, filtered corrections, derived positioning data, and/or metadata associated with the positioning solution. In some implementations, the transmitted information can include both validated messages (e.g., messages that have completed delayed validation) and unvalidated messages (e.g., messages awaiting hash disclosure), allowing downstream receivers to perform validation upon receipt of subsequent hash points.

In variants, downstream receivers can independently verify forwarded messages using the same hash chain and signed hash point used by the original receiver, thereby maintaining end-to-end cryptographic integrity without requiring per-message asymmetric digital signatures at each transmission hop. This architecture can reduce bandwidth usage from a central sender, improve redundancy in the event of intermittent connectivity, and enable cooperative positioning, synchronized movement, formation control, collision avoidance, shared mapping, and/or coordinated task execution across the fleet. In some variants, forwarding can occur contemporaneously with determining the positioning solution, periodically, upon detecting a new receiver joining the network, or in response to a request from another device.

In further variants, a receiver can selectively transmit positioning solutions or validated corrections based on geospatial proximity, operational grouping, trust relationships, subscription models, or predefined coordination policies. For example, only receivers within a defined geographic region, task group, or communication cluster can receive forwarded data. However, transmission policies can be otherwise defined.

However, determining a GNSS receiver positioning solution S500 may be otherwise performed.

The method can optionally include controlling a receiver and/or receiving device based on the GNSS receiver positioning solution S600. Controlling a receiving device functions to adjust, navigate, or manage one or more systems or devices (e.g., in real time, etc.) according to the positioning data derived from the GNSS corrections. S600 can enable responsive control of mobile, autonomous, or semi-autonomous devices (e.g., allowing the receiver to perform navigation, path-following, obstacle avoidance, speed adjustment, orientation correction, and other operational decisions based on the determined position, velocity, acceleration, or other state variables, etc.). S600 can be performed contemporaneously with S300, S400, and/or S500, after S300, after S400, after S500, and/or at any suitable time relative to the other steps. In some variants, S600 can be performed as messages are being received. For example, the receiver may be controlled (e.g., based on the GNSS receiver positioning solution) as the receiver continues to receive and/or validate corrections messages. However, S600 can be performed in any suitable manner.

Controlling the receiver using S600 can include adjusting operational parameters in real or near-real time according to the positioning solution. The control can be implemented using onboard processing systems, embedded controllers, field-programmable gate arrays (FPGAs), digital signal processors (DSPs), microcontrollers, or industrial programmable logic controllers (PLCs) that interface with actuators, motors, servos, steering systems, throttle control, braking systems, and/or other electromechanical or electronic control devices.

For example, in an autonomous vehicle, S600 can enable steering corrections, braking or acceleration adjustments, lane keeping, trajectory updates, or coordinated movement in response to updated GNSS positions, with commands issued via the vehicle's electronic control units (ECUs). In unmanned aerial systems or drones, S600 can allow automatic altitude stabilization, flight path modification, formation control, or waypoint navigation through onboard flight controllers, autopilot modules, or servo control loops. In robotic devices or agricultural equipment, S600 can facilitate precise path tracking, implement automated material handling routines, and coordinate multi-unit operation through robotic controllers, motor drivers, or PLC interfaces. In each of these variants, the control can be continuously updated as new GNSS corrections are received, validated, and incorporated into the positioning solution.

In variants, controlling the receiver S600 can include issuing commands, adjusting setpoints, or triggering autonomous routines based on predetermined thresholds, geofences, or operational objectives. For example, S600 can trigger a lawn-mowing robot to follow a target mowing pattern (e.g., with centimeter level accuracy), adjust a delivery drone's trajectory to avoid no-fly zones, or activate location-based safety protocols in industrial machinery. The method can further allow multi-device coordination, in which a plurality of receivers communicate or act cooperatively using the corrected positioning information to perform synchronized or complementary tasks, while maintaining security and authenticity through validated GNSS corrections.

However, controlling a receiver and/or receiving device based on the GNSS receiver positioning solution S600 may be otherwise performed.

The method can optionally include recovering a latest (e.g., most recent) state of a message stream S1000, which functions to handle mid-stream client connections seamlessly and enable a receiver to receive messages mid-stream (e.g., after a disconnection or interruption between the sender and receiver). The recovery process of S1000 can allow clients to establish trust and start validating messages without needing the full message history (and saving bandwidth and some compute costs). S1000 can be performed after a message stream has begun, mid-message stream, in response to a request, after a receiver subscribes to the message stream (e.g., via MQTT topics or any communication mechanism), or at any suitable time.

Recovering the latest state of the stream S1000 can include receiving all past sent messages and/or hash points of the stream. In variants, S1000 can use a persistent communication mechanism to provide the latest signed terminal hash point (and other currently disclosed keys). For example, Message Queuing Telemetry Transport (MQTT) can be used to provide a receiver all necessary information to recover or determine the message state. Other potential mechanisms can include Advanced Message Queuing Protocol (AMQP), Data Distribution Service (DDS), NATS, Apache Kafta, Pulsar, CoAP, XMPP, email, message queues, or any suitable communication mechanism. However, any mechanism that provides clients with an up-to-date view signed hash and disclosed hash points can be used.

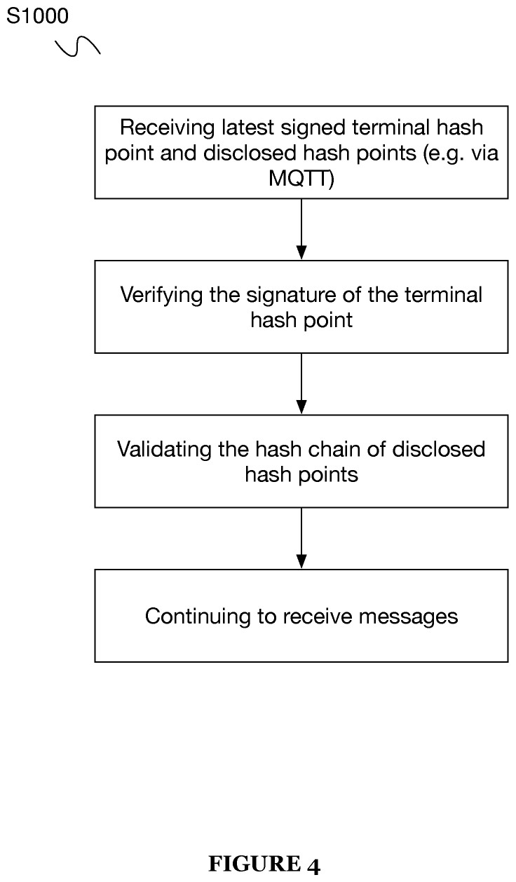

Recovering the latest state of the stream S1000 can include validating the past messages of the stream after receiving the latest signed hash point (e.g. signed h_{end}) and a list of all disclosed hash points (e.g. via MQTT or any other method), as shown for example in FIG. 4. Validating the past messages can include verifying the signature on the signed hash to confirm its authenticity (e.g. as described in S400), hashing through the disclosed keys to ensure integrity of chain (e.g. as described in S400), and/or any other suitable validation methods. In variants, after S1000, the receiver can continue to receive messages of the stream (e.g. in real time).

However, recovering the latest state of a message stream S1000 can be otherwise performed.

In a first illustrative example of the method, the method can be used to control autonomous robotic lawn mowers operating across multiple residential or commercial properties. The method determines a series of GNSS corrections and transmits them to each robotic lawn mower, allowing precise real-time position estimation within the mowing area. Using the corrections, each mower can autonomously adjust its trajectory to maintain defined boundaries, avoid obstacles such as trees or garden features, and coordinate with neighboring mowers to prevent overlap or collisions. High-speed message transmission ensures that even at peak mower speed, positional updates remain accurate, while the hash chain and digitally signed terminal hash can hinder or prevent malicious actors from injecting false positioning or control signals. Delayed validation of the hash chain allows each mower to authenticate the received corrections before taking any corrective actions, such as changing direction or pausing, ensuring both safety and operational reliability in environments with potential network interruptions.

In a second illustrative example of the method, the method can be used for tracking pets or livestock (e.g., equipped with GNSS-enabled collars). The high-rate GNSS corrections transmitted using the method enable collars to maintain accurate location estimates even in areas with signal degradation, such as dense forests, urban canyons, or rolling terrain. Based on the received corrections, the devices can trigger real-time actions such as updating a mobile application with precise locations, activating proximity alerts when a pet or animal leaves a defined safe zone, and/or generating geofencing alerts for automated containment. Persistent retained messaging topics allow newly deployed collars to quickly recover the current state of corrections and authenticate them without requiring the full message history, while cryptographic verification using the hash chain ensures that malicious actors cannot spoof positions to cause false alerts or mislead owners.

In a third illustrative example of the method, the method can be used in autonomous vehicle navigation for last-mile delivery, warehouse automation, or urban mobility solutions. Vehicles receive GNSS corrections at high rates, enabling real-time trajectory adjustments to navigate complex environments with static and dynamic obstacles, such as pedestrians, parked vehicles, and other moving vehicles. Based on the received corrections, the vehicles can make automated control decisions including steering adjustments, speed regulation, route re-planning, or obstacle avoidance. The hash chain-based verification ensures that positioning information is authentic and prevents attackers from sending false GNSS corrections that could misdirect vehicles or trigger unsafe maneuvers. Persistent retained topics allow vehicles that join the network mid-route to synchronize with the current stream of corrections and immediately operate safely without needing to reconstruct the entire historical data set.

In a fourth illustrative example of the method, the method can support mobile industrial robots or construction machinery operating on large or dynamically changing work sites, such as warehouses, mining areas, or construction zones. Each robot or vehicle receives high-speed GNSS corrections, which allow the machinery to continuously update its position relative to site maps, obstacles, and other mobile units. Based on the corrections, the machinery can autonomously adjust movement patterns to optimize workflow, avoid collisions with humans or other machines, and execute precision tasks such as material handling, excavation, or load placement. The method's cryptographic safeguards, including hash chains and digitally signed terminal hashes, prevent the injection of false GNSS corrections that could disrupt operations or compromise safety. The use of persistent retained topics allows new robots or machinery entering the site to immediately recover the latest authenticated state and integrate safely into ongoing operations without interrupting existing workflows or risking collisions.

In a fifth illustrative example of the method, the method can be used for coordinated drone surveying or aerial mapping across a geographic area. A lead drone can receive GNSS corrections and validate them using the hash chain and signed terminal hash. The validated corrections, along with intermediate hash disclosures, can then be transmitted to a fleet of other drones operating nearby, enabling each drone to maintain precise position estimates in real time (e.g., without each drone independently retrieving the full correction stream), for example as shown in FIG. 5. Using the shared corrections, the drones can autonomously adjust flight paths to optimize coverage, avoid mid-air collisions, maintain formation patterns, and dynamically respond to unexpected obstacles such as other aircraft or changes in terrain. Delayed hash validation can ensure that each drone authenticates received corrections before executing trajectory adjustments, while cooperative sharing can reduce bandwidth demands on the central transmitter and improves resilience in environments with intermittent connectivity or limited communication range.

### 5. Specific Examples

Specific Example 1. A system comprising: a corrections generator configured to: determine a series of corrections data for satellite signals; generate a hash chain comprising N hash values and a terminal hash value, wherein N is an integer value; initialize a validity window of the hash chain by signing the terminal hash value with a timestamp; publish the signed terminal hash value to a persistent retained messaging thread; for each n such that 1≤n≤N−1, during a validity window: generate a message Mₙ comprising: an n^{th} correction datum of the series, a message authentication code determined based on the n^{th} correction datum and an n^{th} hash value of the hash chain, and a (n+1)^{th} hash value of the hash chain; transmit message Mₙ; and publish the (n+1)^{th} hash value to the persistent retained messaging thread; and a GNSS receiver in communicative connection with the correction generator, comprising: a processor configured to, for each message: receive the message Mₙ, validate message Mₙ using the n^{th} hash value received in message Mₙ₋₁, and when Mₙ is validated, determine a positioning solution of the GNSS receiver based on Mₙ.

Specific Example 2. The system of Specific Example 1, wherein the series of correction data comprises at least one of low-rate corrections, satellite clock corrections, satellite orbit corrections, code bias corrections, atmospheric delays, or phase bias corrections.

Specific Example 3. The system of Specific Example 1, wherein the GNSS receiver is further configured to transmit the positioning solution to a second GNSS receiver.

Specific Example 4. The system of Specific Example 1, wherein the GNSS receiver is integrated in an autonomous vehicle.

Specific Example 5. The system of Specific Example 1, wherein the corrections generator is further configured to: transmit a final message M₀ to the GNSS receiver, wherein the final message M₀ consists of a 1st hash value of the hash chain

Specific Example 6. The system of Specific Example 1, wherein the corrections generator is further configured to: transmit an initial message M_{N} and the terminal hash value of the hash chain to the GNSS receiver, wherein the initial message M_{N} consists of: a N^{th} correction datum of the series; a message authentication code determined based on the N^{th} correction datum and an N^{th} hash value of the hash chain.

Specific Example 7. The system of Specific Example 1, wherein the message is not signed before transmitting.

Specific Example 8. The system of Specific Example 1, wherein signing the terminal hash value comprises performing at least 8 cryptographic operations per second.

Specific Example 9. The system of Specific Example 1, wherein the validity window is between 100 and 300 seconds.

Specific Example 10. The system of Specific Example 1, wherein, when connection with the corrections generator is established after at least one message is transmitted, the processor of the GNSS receiver is further configured to: retrieve the terminal hash value and the published hash values from the persistent retained messaging thread; verify a signature of the terminal hash value; and validate the published hash values based on the terminal hash value.

Specific Example 11. A method comprising: determining a series of corrections data for satellite signals; generating a hash chain comprising a plurality of hash values and a terminal hash value; initializing a validity window of the hash chain by signing a terminal hash value of the hash chain with a timestamp; publishing the signed terminal hash value to a persistent retained messaging thread accessible by a set of mobile receivers; for each hash value of the plurality of hash values: generating a message comprising a corrections datum of the series of corrections data, a message authentication code determined based on the corrections datum and the hash value, and a preceding-message hash value of the hash chain, wherein the preceding-message hash value is associated with the message authentication code to a preceding message, transmitting the message to the set of mobile receivers within the validity window, and publishing the preceding-message hash value to the persistent retained messaging thread; wherein each mobile receiver of the set of mobile receivers determines a respective positioning solution using the corrections datum from the message.

Specific Example 12. The method of Specific Example 11, further comprising transmitting a terminal message consisting of a final-message hash value.

Specific Example 13. The method of Specific Example 11, further comprising, at the set of mobile receivers, receiving the messages and validating the messages, wherein validating the messages comprises validating each message using a hash value received from a subsequently received message.

Specific Example 14. The method of Specific Example 11, wherein the set of mobile receivers comprises a fleet of autonomous vehicles.

Specific Example 15. The method of Specific Example 11, wherein the fleet of autonomous vehicles comprises robotic lawn mowers.

Specific Example 16. The method of Specific Example 11, wherein the set of mobile receivers comprises at least 25 mobile receivers.

Specific Example 17. The method of Specific Example 11, wherein the validity window has a duration of at most five minutes.

Specific Example 18. The method of Specific Example 11, wherein the preceding-message hash value corresponds with a preceding message that was sent at least one message prior.

Specific Example 19. The method of Specific Example 11, wherein signing comprises performing at least 8 cryptographic operations per second.

Specific Example 20. The method of Specific Example 11, wherein generating the message does not comprise digitally signing the message.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A system comprising:
a corrections generator configured to:
determine a series of corrections data for satellite signals
generate a hash chain comprising N hash values and a terminal hash value, wherein N is an integer value;
initialize a validity window of the hash chain by signing the terminal hash value with a timestamp;
publish the signed terminal hash value to a persistent retained messaging thread;
for each n such that 1≤n≤N−1, during a validity window:
generate a message Mₙ comprising:
an n^{th} correction datum of the series;
a message authentication code determined based on the n^{th} correction datum and an n^{th} hash value of the hash chain; and
a (n+1)^{th} hash value of the hash chain;
transmit message Mₙ; and
publish the (n+1)^{th} hash value to the persistent retained messaging thread; and
a GNSS receiver in communicative connection with the correction generator, comprising:
a processor configured to, for each message:
receive the message Mₙ;
validate message Mₙ using the n^{th} hash value received in message Mₙ₋₁; and
when Mₙ is validated, determine a positioning solution of the GNSS receiver based on Mₙ.

2. The system of claim 1, wherein the series of correction data comprises at least one of low-rate corrections, satellite clock corrections, satellite orbit corrections, code bias corrections, atmospheric delays, or phase bias corrections.

3. The system of claim 1, wherein the GNSS receiver is further configured to transmit the positioning solution to a second GNSS receiver.

4. The system of claim 1, wherein the GNSS receiver is integrated in an autonomous vehicle.

5. The system of claim 1, wherein the corrections generator is further configured to: transmit a final message M₀ to the GNSS receiver, wherein the final message M₀ consists of a 1st hash value of the hash chain.

6. The system of claim 1, wherein the corrections generator is further configured to: transmit an initial message M_{N} and the terminal hash value of the hash chain to the GNSS receiver, wherein the initial message M_{N} consists of:
a N^{th} correction datum of the series;
a message authentication code determined based on the N^{th} correction datum and an N^{th} hash value of the hash chain.

7. The system of claim 1, wherein the message is not signed before transmitting.

8. The system of claim 1, wherein signing the terminal hash value comprises performing at least 8 cryptographic operations per second.

9. The system of claim 1, wherein the validity window is between 100 and 300 seconds.

10. The system of claim 1, wherein, when connection with the corrections generator is established after at least one message is transmitted, the processor of the GNSS receiver is further configured to:
retrieve the terminal hash value and the published hash values from the persistent retained messaging thread;
verify a signature of the terminal hash value; and
validate the published hash values based on the terminal hash value.

11. A method comprising:
determining a series of corrections data for satellite signals;
generating a hash chain comprising a plurality of hash values and a terminal hash value;
initializing a validity window of the hash chain by signing a terminal hash value of the hash chain with a timestamp;
publishing the signed terminal hash value to a persistent retained messaging thread accessible by a set of mobile receivers;
for each hash value of the plurality of hash values:
generating a message comprising a corrections datum of the series of corrections data, a message authentication code determined based on the corrections datum and the hash value, and a preceding-message hash value of the hash chain, wherein the preceding-message hash value is associated with the message authentication code to a preceding message;
transmitting the message to the set of mobile receivers within the validity window; and
publishing the preceding-message hash value to the persistent retained messaging thread;
wherein each mobile receiver of the set of mobile receivers determines a respective positioning solution using the corrections datum from the message.

12. The method of claim 11, further comprising transmitting a terminal message consisting of a final-message hash value.

13. The method of claim 11, further comprising, at the set of mobile receivers, receiving the messages and validating the messages, wherein validating the messages comprises validating each message using a hash value received from a subsequently received message.

14. The method of claim 11, wherein the set of mobile receivers comprises a fleet of autonomous vehicles.

15. The method of claim 11, wherein the fleet of autonomous vehicles comprises robotic lawn mowers.

16. The method of claim 11, wherein the set of mobile receivers comprises at least 25 mobile receivers.

17. The method of claim 11, wherein the validity window has a duration of at most five minutes.

18. The method of claim 11, wherein the preceding-message hash value corresponds with a preceding message that was sent at least one message prior.

19. The method of claim 11, wherein signing comprises performing at least 8 cryptographic operations per second.

20. The method of claim 11, wherein generating the message does not comprise digitally signing the message.
